(19) United States
(12) Patent Application Publication
(10) Pub. No.: US 2024/0144393 A1
(43) Pub. Date: May 2, 2024

(54) METHOD FOR PROVIDING RECOMMENDED CHAT ROOM FOR SENDING MESSAGE, AND APPARATUS FOR IMPLEMENTING THE SAME

(71) Applicant: Samsung SDS Co., Ltd., Seoul (KR)

(72) Inventors: Ji Eun YOON, Seoul (KR); Moon Young Kwon, Seoul (KR); Sun Hyo Lee, Seoul (KR)

(73) Assignee: Samsung SDS Co., Ltd., Seoul (KR)

(21) Appl. No.: 18/384,705

(22) Filed: Oct. 27, 2023

(30) Foreign Application Priority Data
Oct. 28, 2022 (KR) 10-2022-0141539

(51) Int. Cl. G06Q 50/00; H04L 51/046

(52) U.S. Cl. CPC G06Q 50/01; H04L 51/046

(57) ABSTRACT

Provided is a method for providing a recommended chat room for sending a message. The method, which is performed by at least one processor, includes: identifying a user matching a name entered on a message writing screen; and providing a recommended chat room list in which at least one chat room having the user is displayed.

### CROSS-REFERENCE TO RELATED APPLICATION(S)

This application is based on and claims priority under 35 U.S.C. § 119 to Korean Patent Application No. 10-2022-0141539, filed on Oct. 28, 2022, in the Korean Intellectual Property Office, the disclosure of which is incorporated by reference herein in its entirety.

### BACKGROUND

### 1. Field

The disclosure relates to a method for providing a recommended chat room for sending a message, and an apparatus for implementing the same. More particularly, the disclosure relates to a method for providing a recommended chat room for sending a message in order to provide information on a recommended chat room when writing a message, and an apparatus for implementing the same.

### 2. Description of the Related Art

A messenger application for business has characteristics that a plurality of chat rooms are created in a similar member configuration according to business unlike a business to consumer (B2C) messenger application in which a conversation is initiated only with limited members or in a limited chat room. Therefore, similar conversations occur in several chat rooms, and thus, it is difficult to search for a history of messages. In addition, when a user sends messages to several persons for business purposes, the user may send the messages to one-to-one (1:1) chat rooms or send the messages at a time to group chat rooms. The user should look for and enter the corresponding 1:1 chat rooms or group chat rooms one by one in some cases, which is troublesome.

When the user uses the messenger application for business on a mobile apparatus, it is impossible to confirm an utterance history of a specific user who has integrated other chat rooms when writing a message due to a limitation on screen. There is a limitation that the user may send the messages only in the chat room that he/she has entered. In addition, in order to send the messages, a process of searching the previously created chat rooms or creating a new 1:1 chat room or group chat room should be performed, which is inconvenient.

Conventionally, in order to confirm the utterance history of the specific user, a messenger search function should be utilized or a process of entering and searching individual chat rooms should be performed. Several standardized processes such as processes of reentering a chat room in which the message should be actually written, sending the message, and exiting the chat room in order to receive a new message notification should be performed, which is inconvenient.

Accordingly, there is a need for a technology capable of providing convenience to a user by reducing steps required for searching chat rooms, creating a new chat room, and searching for an utterance history when using a messenger for business.

In addition, it is necessary to provide a function of automatically searching chat rooms and conversation histories to which a user who will receive a message belongs when writing the message.

### SUMMARY

Aspects of the disclosure provide a method for providing a recommended chat room for sending a message capable of reducing steps for sensing a message by identifying a user who will receive the message while writing the message on a messenger and automatically recommending a chat room to which the user belongs, and an apparatus for implementing the same.

Aspects of the disclosure also provide a method for providing a recommended chat room for sending a message capable of providing convenience to a user by reducing steps required to search for an utterance history of a user who will receive the message while writing the message on a messenger, and an apparatus for implementing the same.

Aspects of the disclosure also provide a method for providing a recommended chat room for sending a message capable of providing a convenient interface so that search of a chat room, creation of a new chat room, and search of an utterance history are all possible on a screen on which a message is written, and an apparatus for implementing the same.

However, aspects of the disclosure are not restricted to those set forth herein. The above and other aspects of the disclosure will become more apparent to one of ordinary skill in the art to which the disclosure pertains by referencing the detailed description of the disclosure given below.

According to an aspect of the disclosure, a method for providing a recommended chat room for sending a message, the method, which is performed by at least one processor, includes: identifying a user matching a name entered on a message writing screen; and providing a recommended chat room list in which at least one chat room having the user is displayed.

In some embodiments, the identifying of the user includes, based on a determination that a preset symbol is entered on the message writing screen, identifying the user matching the name that is entered consecutively to the preset symbol.

In some embodiments, the method further includes: based on at least one chat room being selected from the recommended chat room list, providing a user interface (UI) for sending a message entered on the message writing screen to the selected at least one chat room.

In some embodiments, the providing of the recommended chat room list includes, based on a determination that the at least one chat room having the user does not exist, displaying a new chat room creation user interface (UI) with the user in the recommended chat room list.

In some embodiments, the method further includes: providing a recommended conversation history including conversation contents relevant to a keyword extracted from a message entered on the message writing screen among conversation contents of the at least one chat room included in the recommended chat room list.

In some embodiments, the providing of the recommended conversation history includes, based on a determination that a conversation history having the user exists, displaying the recommended conversation history.

In some embodiments, the providing of the recommended conversation history includes, based on a determination that a conversation history having the user does not exist, providing a recommendation function of a similar conversation history.

In some embodiments, the providing of the recommendation function of the similar conversation history includes displaying the similar conversation history including conversation contents relevant to the keyword extracted from the message entered on the message writing screen among conversation contents of a chat room that does not include the user and includes only a writer of the message.

In some embodiments, the providing of the recommended conversation history includes: displaying the recommended chat room list in a first area of the message writing screen, and displaying the recommended conversation history in a second area of the message writing screen.

In some embodiments, the user is a first user, and the method further includes: based on a determination that a second symbol is additionally entered on the message writing screen, identifying a second user matching a name that is entered consecutively to the additionally entered second symbol; displaying at least one chat room having both the first user and the second user in the recommended chat room list; and displaying conversation histories that have occurred in the at least one chat room having both the first user and the second user in a recommended conversation history.

In some embodiments, the displaying of the at least one chat room having both the first user and the second user in the recommended chat room list includes, based on a determination that the at least one chat room having both the first user and the second user does not exist, displaying a new chat room creation user interface (UI) having the first user and the second user in the recommended chat room list.

In some embodiments, the displaying of the conversation histories that have occurred in the at least one chat room including both the first user and the second user in the recommended conversation history includes providing a user interface (UI) filtering each of conversation histories of the first user and the second user displayed in the recommended conversation history.

In some embodiments, the displaying of the at least one chat room including both the first user and the second user in the recommended chat room list includes: displaying an individual send user interface (UI) to a one-to-one chat room having each of the first user and the second user in the recommended chat room list; dividing a message entered on the message writing screen into a first message corresponding to the first user and a second message corresponding to the second user and, based on the individual send UI being selected, displaying the divided first message and second message; and sending the first message to a first one-to-one chat room having the first user and sending the second message to a second one-to-one chat room having the second user.

In some embodiments, the method further includes: providing a user interface (UI) for displaying a recommended conversation history corresponding to each of the first message and the second message.

In some embodiments, the method further includes: displaying a chat room direct select user interface (UI) in the recommended chat room list; based on the chat room direct select UI being selected, displaying a list of all chat room lists; and sending the message to at least one chat room selected from the list of all chat rooms.

According to an aspect of the disclosure, a non-transitory computer-readable recording medium storing computer program, which, when executable by at least one processor, causes the at least one processor to execute: identify a user matching a name entered on a message writing screen; and provide a recommended chat room list in which at least one chat room having the user is displayed.

According to an aspect of the disclosure, messenger client terminal includes: one or more processors; a memory configured to load a computer program executable by the one or more processors; and wherein the computer program includes instructions for performing: identifying a user matching a name entered on a message writing screen; and providing a recommended chat room list in which at least one chat room having the user is displayed.

### BRIEF DESCRIPTION OF THE DRAWINGS

The above and other aspects and features of the disclosure will become more apparent by describing in detail example embodiments thereof with reference to the attached drawings, in which:

FIG. 1 is a view illustrating a configuration of a system for providing a recommended chat room for sending a message according to an example embodiment of the disclosure;

FIG. 2 is a flowchart for describing a method for providing a recommended chat room for sending a message according to an example embodiment of the disclosure;

FIG. 3 is a flowchart for describing detailed processes of some steps illustrated in FIG. 2;

FIG. 4 is a flowchart for describing a process additionally performed after steps illustrated in FIG. 2;

FIG. 5 is a flowchart for describing detailed processes of a step illustrated in FIG. 4;

FIG. 6 is an example of an interface for entering a message writing screen in a chat room list according to some example embodiments of the disclosure;

FIG. 7 is an example of providing a chat room and a conversation history to which a user entered when writing a message belongs according to some example embodiments of the disclosure;

FIG. 8 is an example of an interface for creating a new chat room of a user of which a conversation history does not exist when writing a message according to some example embodiments of the disclosure;

FIG. 9 is an example of providing a chat room and a conversation history to which a plurality of users entered when writing a message belong according to some example embodiments of the disclosure;

FIG. 10 is an example of dividing and sending a message to each of a plurality of users entered when writing a message according to some example embodiments of the disclosure;

FIG. 11 is an example of sending messages to several chat rooms to which a plurality of users entered when writing a message belong according to some example embodiments of the disclosure;

FIG. 12 is an example of selecting a chat rooms other than a recommended chat room and sending a message to a plurality of users entered when writing a message in the selected chat room according to some example embodiments of the disclosure; and

FIG. 13 is a hardware configuration diagram of an illustrative computing apparatus capable of implementing methods according to an example embodiment of the disclosure.

### DETAILED DESCRIPTION

Hereinafter, preferred embodiments of the disclosure will be described with reference to the attached drawings. The advantages and features of the disclosure and methods of accomplishing the same may be understood more readily by reference to the following detailed description of preferred embodiments and the accompanying drawings. The disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the disclosure will only be defined by the appended claims.

In adding reference numerals to the components of each drawing, the same reference numerals are assigned to the same components as much as possible even though they are shown in different drawings. In addition, in describing the disclosure, when it is determined that the detailed description of the related well-known configuration or function may obscure the gist of the disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. Similarly, the term “set” means one or more.

Hereinafter, some embodiments of the disclosure will be described in detail with reference to the accompanying drawings.

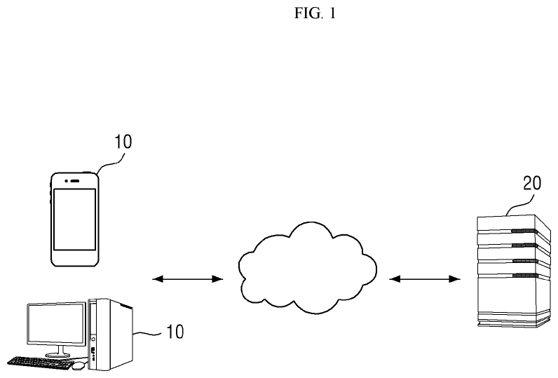

FIG. 1 is a view illustrating a configuration of a system for providing a recommended chat room for sending a message according to an example embodiment of the disclosure. Referring to FIG. 1, the system according to an example embodiment of the disclosure includes a messenger client terminal 10 and a server 20, and the messenger client terminal 10 is connected to the server 20 through a network.

The messenger client terminal 10 may be implemented as a terminal that provides information on at least one chat room including a user entered on a message writing screen of a messenger. In this case, the messenger client terminal 10 may receive a user profile, information on a plurality of chat rooms relevant to the user, and information on an existing conversation history or the like of the user from the server 20 in order to provide the information on the chat room including the user. The messenger client terminal 10 may be, for example, any one of a mobile computing apparatus such as a smartphone, a tablet personal computer (PC), a laptop computer, and a personal digital assistant (PDA), and a fixed computing apparatus such as a desktop PC.

When a name entered on the message writing screen of the messenger is sensed, the messenger client terminal 10 identifies a user matching the name. In this case, when the number of users matching the name is plural, the message client terminal preferentially extracts a user relevant to a writer of the message. For example, the message client terminal may extract a user who has an existing conversation history with the writer of the message, a user relevant to the write of the message in terms of business, or the like.

The messenger client terminal 10 provides a recommended chat room list in which at least one chat room including the user identified described above is displayed.

In this case, the messenger client terminal 10 may select one or a plurality of chat rooms of chat rooms displayed in the recommended chat room list and send a message to the selected chat room.

The messenger client terminal 10 may provide an interface capable of creating a new one-to-one chat room with the identified user when the chat room including the user does not exist.

In addition, the messenger client terminal 10 may provide a conversation history including the identified user as a recommended conversation history. As an example, the messenger client terminal 10 may provide conversation contents relevant to an entered message among conversation contents of the chat rooms displayed in the recommended chat room list, that is, chat rooms including the user, as a recommended conversation history. In this case, the recommended chat room list may be displayed in a first area of the message writing screen, and the recommended conversation history may be displayed in a second area of the message writing screen different from the first area.

When the conversation history including the identified user does not exist, a similar conversation history may be provided instead of the recommended conversation history. Here, the similar conversation history may include conversation contents relevant to the entered message among conversation contents of chat rooms that do not include the identified user but include the writer of the message.

When the number of users matching the name entered on the message writing screen is two or more, the messenger client terminal 10 may provide chat rooms including all of the identified two or more users as the recommended chat room list, and provide a recommended conversation history relevant to the message among conversation contents of the chat rooms including all of the identified two or more users.

According to the configuration of the system of the disclosure as described above, it is possible to reduce steps for sensing a message by identifying a user who will receive the message while writing the message on the messenger and automatically recommending a chat room to which the user belongs. That is, it is possible to automatically recommend the chat room and the conversation history that include the user only by mentioning the name of the user while writing the message without searching chat rooms including a desired person, entering several chat rooms, and confirming conversation histories in order to send the message to the desired person.

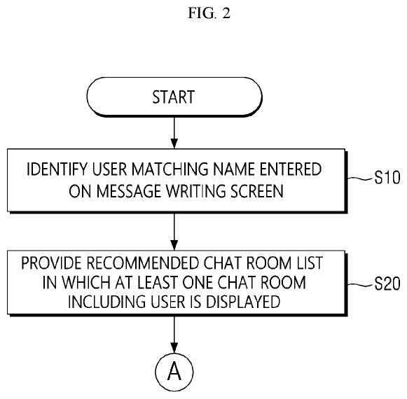

FIG. 2 is a flowchart for describing a method for providing a recommended chat room for sending a message according to an example embodiment of the disclosure.

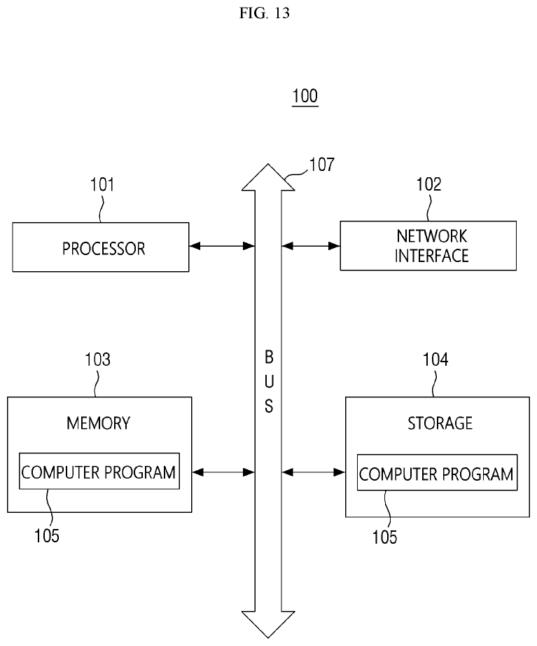

The method for providing a recommended chat room for sending a message according to an example embodiment of the disclosure may be executed by the messenger client terminal 10 illustrated in FIG. 1. The messenger client terminal 10 executing the method according to the present example embodiment may be a computing device 100 illustrated in FIG. 13. The messenger client terminal 10 may be, for example, an apparatus capable of performing an arithmetic function, such as a smartphone, a tablet PC, a laptop computer, or a PC.

A description of a subject performing some operations included in the method according to an example embodiment of the disclosure may be omitted, and in such a case, the subject is the messenger client terminal 10.

According to an example embodiment of the disclosure to be described later, it is possible to recommend a chat room and a conversation history that include a user of an entered name only by an operation of entering a name of a person to whom a message is to be sent on a message writing screen of a messenger.

First, in operation S10, the messenger client terminal 10 identifies a user matching a name entered on a message writing screen.

As an example embodiment, when it is sensed that (in other words, based on a determination or based on an identifying that) a preset symbol such as A is entered on the message writing screen, the messenger client terminal 10 may identify the user matching the name entered consecutively to the symbol.

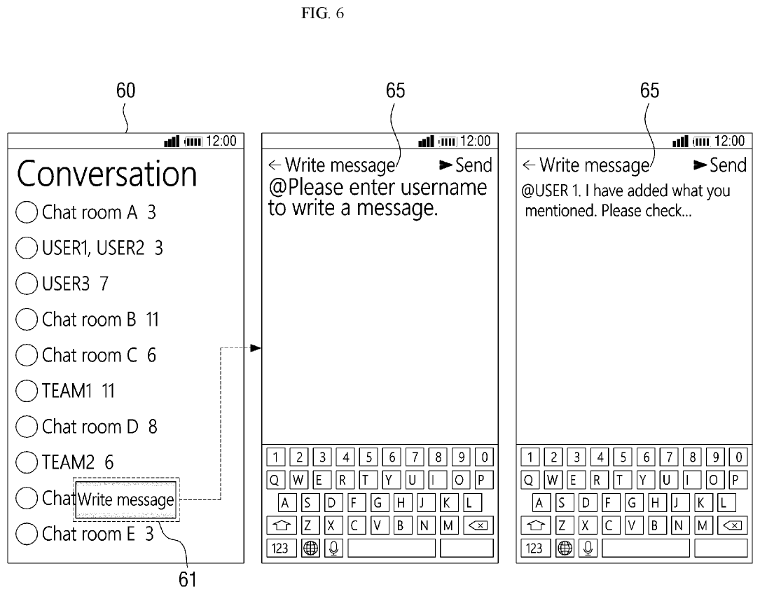

As an example, referring to FIG. 6, the message client terminal 10 may provide a message writing screen 65 capable of writing a message without entering a chat room, based on a selection of a message writing button 61 displayed in one area of a chat room list 60.

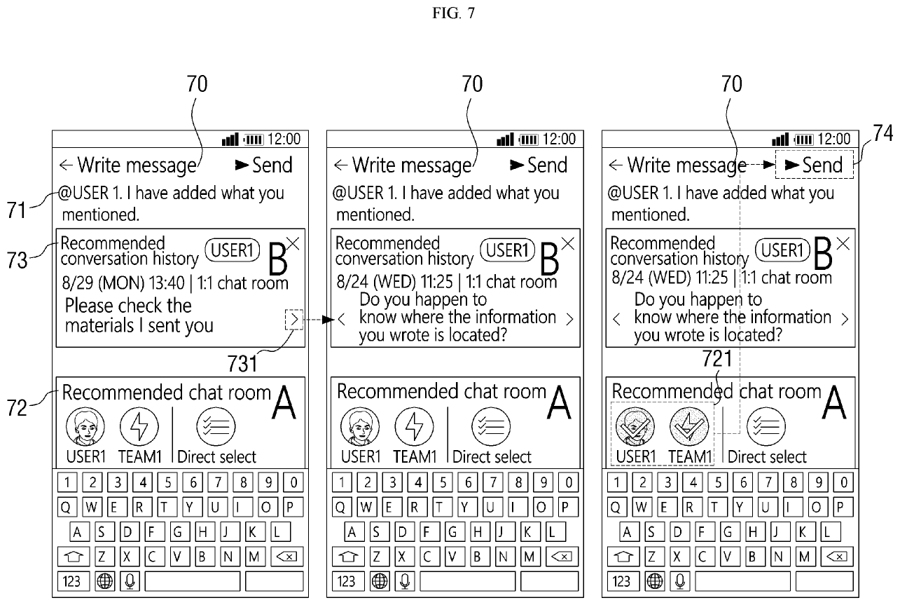

In an example of FIG. 7, when a preset A is sensed in a message entered on a message writing screen 70, the messenger client terminal 10 may identify a user matching USER1 using USER1 71, which is a name entered consecutively to A.

As an example embodiment, when there the number of users matching USER1 is several, the messenger client terminal 10 may extract a plurality of users related to a writer of the message using a collaborative filtering algorithm filtering unnecessary information, and then assign priorities to the respective users in order of high relevance. As an example, a high priority may be assigned to a user of which a chat room or a conversation history with the writer of the message exists, a user belonging to the same department as the writer of the message, or a user relevant to the writer of the message in terms of business among a plurality of users matching USER1. In this case, the messenger client terminal 10 may identify a user to which the highest priority is assigned among the plurality of users matching USER1 as a user for sending the message.

Accordingly, when there the number of users matching the name entered on the message writing screen 70 is several, a user highly related to the writer of the message may be extracted together with an effect of filtering a person of the same name through the collaborative filtering algorithm.

Next, in operation S20, the messenger client terminal 10 provides a recommended chat room list in which at least one chat room including the identified user is displayed. In this case, when at least one chat room is selected from the recommended chat room list, the messenger client terminal 10 may provide a user interface (UI) for sending a message to the selected at least one chat room.

As an example, in an example of FIG. 7, when a user matching USER1 71 entered consecutively to @ on the message writing screen 70 is identified, the messenger client terminal 10 may display at least one chat room including the identified user in a recommended chat room list 72. In this case, according to a user input of selecting some chat rooms 721 from the recommended chat room list 72 and then clicking a send button 74, a message entered on the message writing screen 70 may be sent to the selected chat rooms 721.

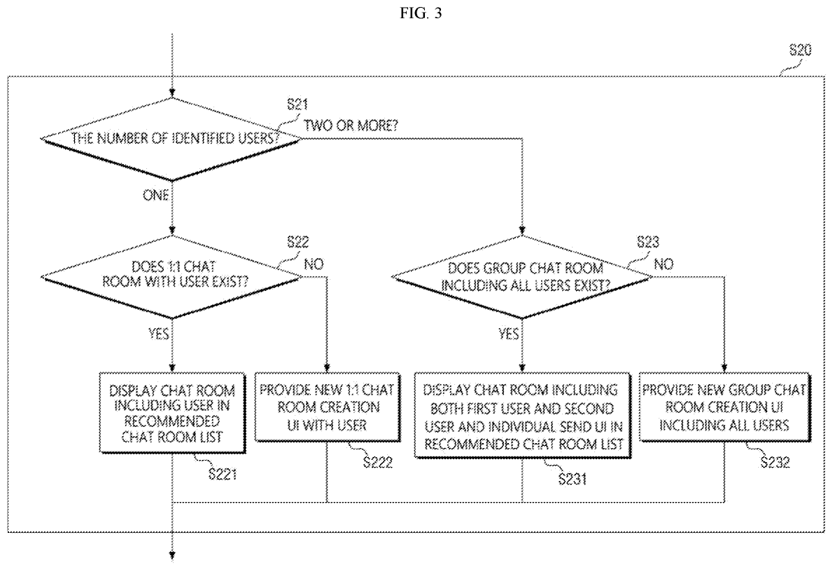

As an example embodiment, referring to FIG. 3, the operation S20 may include an operation S21 of deciding the number of identified users, operations S22, S221, and S222 when the number of identified users is one, and operations S23, S231, and S232 when the number of identified users is two or more.

When the number of identified users is one in operation S21, it may be decided whether or not a 1:1 chat room with the user exists in operation S22, and when the 1:1 chat room exists, a chat room including the user may be displayed in a recommended chat room list in operation S221. When the 1:1 chat room does not exist, a new 1:1 chat room creation UI with the user may be provided in operation S222.

When the number of identified users is two or more in operation S21, it may be decided whether or not a group chat room including all users exists in operation S23, and when the group chat room exists, the group chat room including all users and an individual send UI may be displayed in the recommended chat room list in operation S231. When the group chat room does not exist, a new group chat room creation UI including all users may be provided in operation S232.

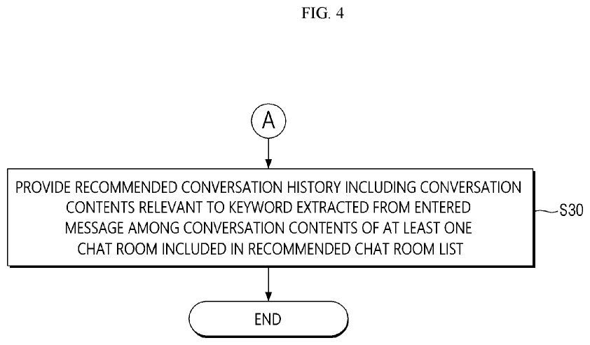

As an example embodiment, referring to FIG. 4, the messenger client terminal 10 may additionally perform an operation S30 after performing the operation S10 and the operation S20 of FIG. 2.

In operation S30, the messenger client terminal 10 may provide a recommended conversation history including conversation contents relevant to a keyword extracted from a message entered on the message writing screen among conversation contents of at least one chat room included in the recommended chat room list. In this case, when the keyword is extracted from the message, for example, a keyword with high importance may be extracted from the message using a text ranking algorithm such as TF-IDF, SMART, INQUERY, and CCA.

As an example, as illustrated in FIG. 7, the messenger client terminal 10 may provide conversation contents having a high relevance as a recommended conversation history 73 through relevance analysis between conversation contents of each of the chat rooms displayed in the recommended chat room list 72 and a main keyword extracted from the message. In this case, a plurality of conversation contents included in the recommended conversation history 73 may be confirmed by scrolling left and right using a search indicator 731.

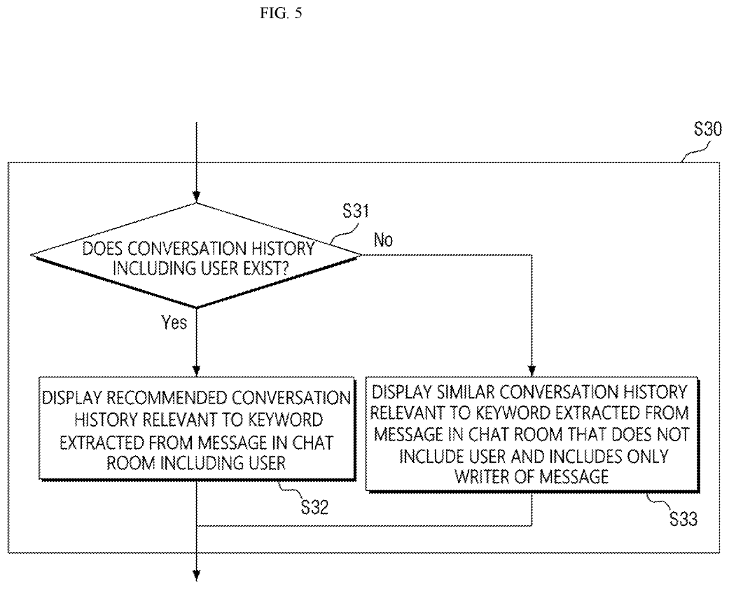

As an example embodiment, referring to FIG. 5, the operation S30 may include an operation S31 of deciding whether or not a conversation history including the user exists, an operation S32 when the conversation history exists, and an operation S33 when the conversation history does not exist.

It may be decided whether or not the conversation history including the user exists in operation S31, and when the conversation history exists, a recommended conversation history including conversation contents relevant to a main keyword extracted from the message among conversation contents of the chat room including the user may be displayed in operation S32.

When the conversation history including the user does not exist in operation S31, a similar conversation history including conversation contents relevant to a main keyword extracted from the message among conversation contents of a chat room that does not include the user and includes only the writer of the message may be displayed in operation S33.

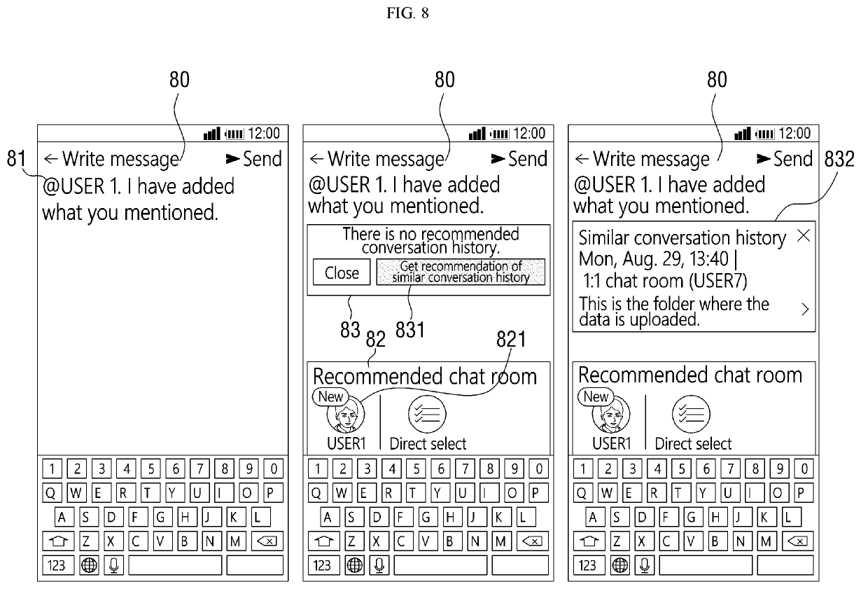

As an example, referring to FIG. 8, the messenger client terminal 10 may display a new one-to-one chat room creation UI 821 in a recommended chat room list 82 so as to create a one-to-one chat room with a user when a chat room including a user matching USER1 81 entered consecutively to @ on a message writing screen 80 does not exist.

In addition, when a conversation history including the user matching USER1 81 does not exist, the messenger client terminal 10 may displays a recommendation UI 831 of a similar conversation history in a display area 83 of the recommended conversation history. In this case, when the recommendation UI 831 of the similar conversation history is selected, the messenger client terminal 10 may display a similar conversation history 832 including conversation contents relevant to a main keyword extracted from an entered message among conversation contents of a chat room that does not include the user and includes only a writer of the message.

Accordingly, it is possible to provide convenience to a user by reducing steps required to search for a conversation history of the user who will receive the message while writing the message on the messenger, and it is possible to search for useful information for sending the message by providing the similar conversation history relevant to the writer even when there is no conversation history of the user.

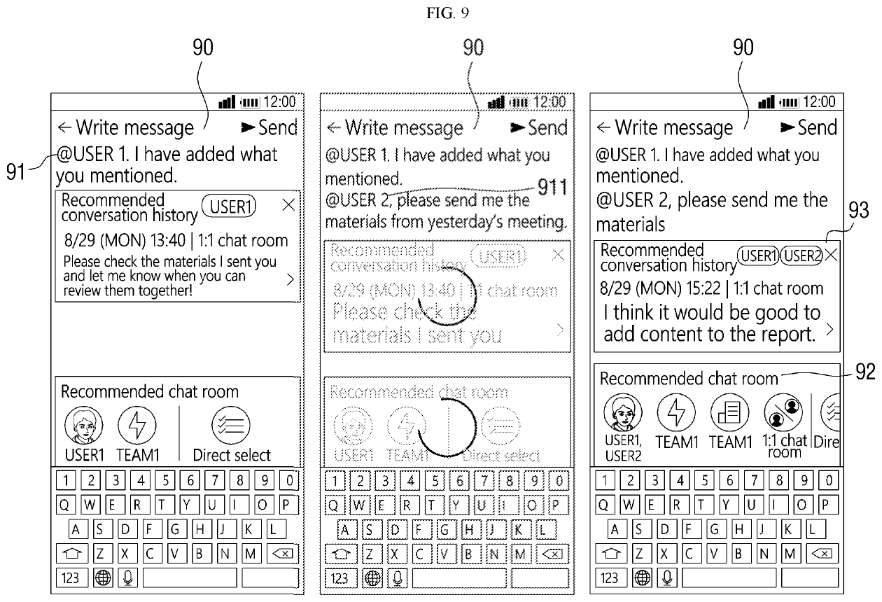

As an example embodiment, referring to FIG. 9, the messenger client terminal 10 may identify a first user matching USER1 91 entered consecutively to @ on a message writing screen 90, and then identify a second user matching USER2 911 entered consecutively to additionally entered @. In this case, the messenger client terminal 10 may display at least one chat room including both the identified first user and second user in a recommended chat room list 92. In addition, the messenger client terminal 10 may display conversation histories of the first user and the second user that have occurred in at least one chat room displayed in the recommended chat room list 92 in a recommended conversation history 93. When the conversation history including both the first user and the second user does not exist, a similar conversation history including conversation contents relevant to a message among conversation contents of chat rooms that do not include the first user and the second user, but include a writer of the message may be provided.

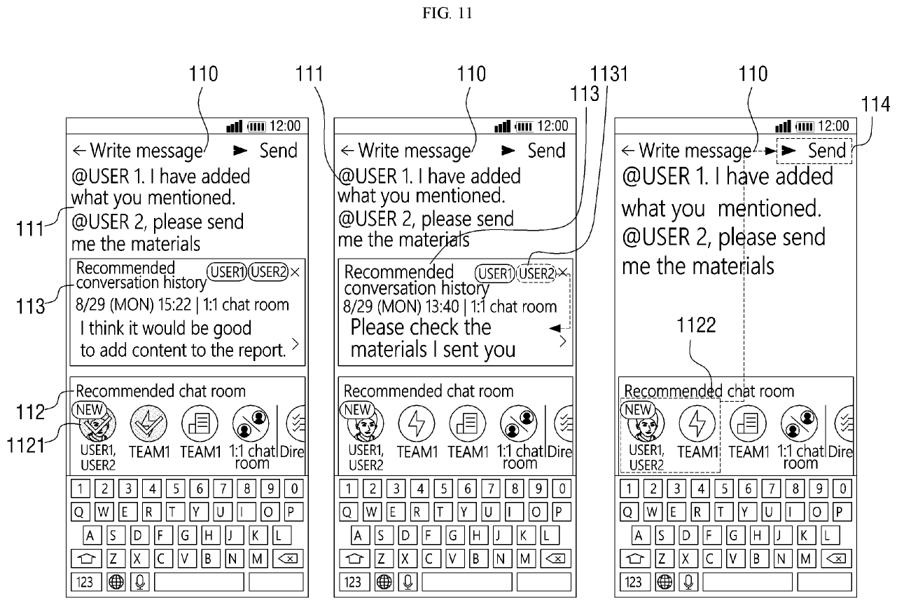

As an example embodiment, as illustrated in FIG. 11, the messenger client terminal 10 may display a new chat room creation UI 1121 including the first user and the second user in a recommended chat room list 112 when at least one chat room including both the first user and the second user does not exist.

In addition, the messenger client terminal 10 may provide a UI capable of filtering each of conversation histories of the first user and the second user displayed in a recommended conversation history 113. As an example, in an example of FIG. 11, each of name chips of USER1 and USER2 may be activated or inactivated, and for example, when a name chip 1131 of USER2 of USER1 and USER2 is inactivated, the conversation history of USER2 may be excluded from the recommended conversation history 113 and only the conversation history of USER1 may be displayed in the recommended conversation history 113.

In addition, the messenger client terminal 10 may select some chat rooms 1122 of several chat rooms including USER1 and USER2 displayed in the recommended chat room list 112, and then click a send button 114 to send the message to the selected chat rooms 1122.

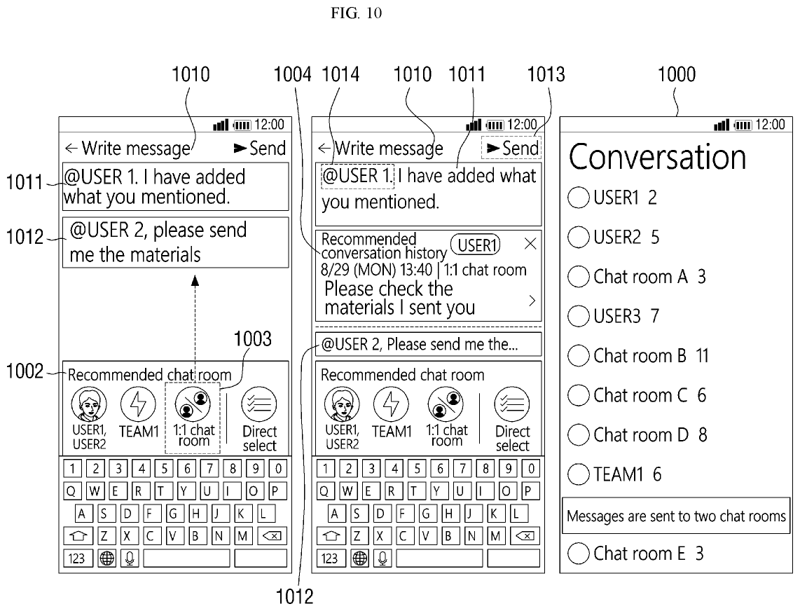

As an example embodiment, referring to FIG. 10, the messenger client terminal 10 may display an individual send UI 1003 to a one-to-one chat room including each of USER1 and USER2 identified in a message entered on a message writing screen 1010 in a recommended chat room list 1002. In this case, when the individual send UI 1003 is selected, the messenger client terminal 10 may divide the message entered on the message writing screen 1010 into a first message 1011 corresponding to USER1 and a second message 1012 corresponding to USER2 and display the divided first message 1011 and second message 1012. In addition, when USER1 is selected in the first message 1011, the messenger client terminal 10 may display a first recommended conversation history 1004 corresponding to the first message 1011. Similarly, when USER2 is selected in the second message 1012, the message client terminal 10 may display a second recommended conversation history corresponding to the second message 1012.

Accordingly, the messenger client terminal 10 may send the first message 1011 to a one-to-one chat room including USER1 and send the second message 1012 to a one-to-one chat room including USER2 by clicking a send button 1013 in a state in which the message is divided into the first message 1011 corresponding to USER1 and the second message 1012 corresponding to USER2.

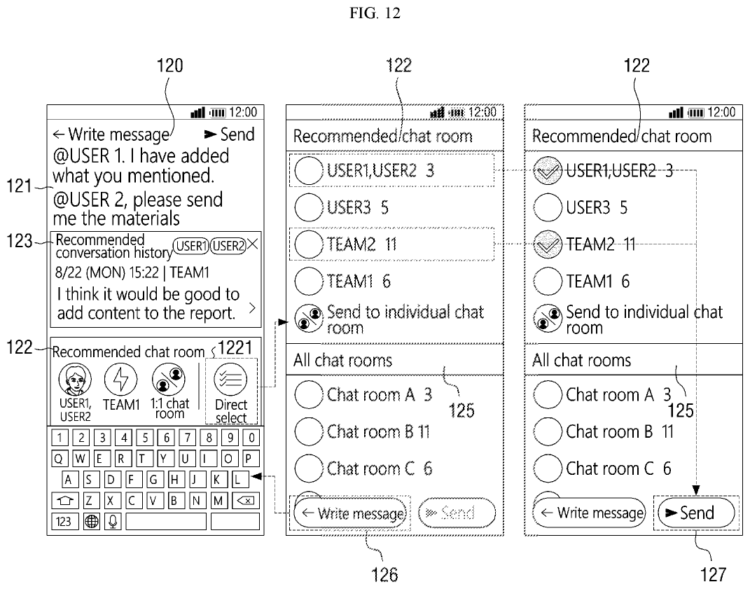

As an example embodiment, as illustrated in FIG. 12, the messenger client terminal 10 may display a chat room direct select UI 1221 in a recommended chat room list 122, and may display sort and display the recommended chat room list 122 at the top of a screen and sort and display a list 125 of all chat rooms at the bottom of the screen when the chat room direct select UI 1221 is selected. In this case, when at least one of chat rooms displayed in each of the recommended chat room list 122 and the list 125 of all chat rooms is selected and a send button 127 is then clicked, a message 121 including both USER1 and USER2 may be sent to the selected at least one chat room.

When a message writing button 126 is selected in a state in which the recommended chat room list 122 and the list 125 of all chat rooms are displayed, the messenger client terminal 10 may switch a screen into a message writing screen 120 and write a message.

As described above, according to the method according to an example embodiment of the disclosure, it is possible to provide a convenient interface so that search of the chat room, creation of the new chat room, and search of an utterance history are all possible on the same screen only by entering the name of the user on the screen on which the message is written. In addition, it is possible to provide an effect of dramatically reducing steps for sending a message by identifying a user who will receive a message on the messenger and automatically recommending a chat room to which the user belongs without needing to search chat rooms and confirm conversation histories one by one in order to send the message. 100.

FIG. 13 is a hardware configuration diagram of an example computing device 100.

Referring to FIG. 13, the computing device 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the disclosure. The computing device 100 may have one or more processors.

The memory 103 stores various data, instructions and/or information. The memory 103 may load one or more programs 105 from the storage 104 to execute methods/operations according to various embodiments of the disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless internet communication of the computing device 100. The network interface 102 may support various communication methods other than internet communication. To this end, the network interface 102 may be configured to comprise a communication module well known in the art of the disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more instructions, on which the methods/operations according to various embodiments of the disclosure are implemented. When the computer program 105 is loaded on the memory 103, the processor 101 may perform the methods/operations in accordance with various embodiments of the disclosure by executing the one or more instructions.

As an example embodiment, the computer program 105 may include instructions for performing an operation of identifying a user matching a name entered on a message writing screen and an operation of providing a recommended chat room list in which at least one chat room including the user is displayed.

The technical features of the disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the disclosure. Therefore, the disclosed preferred embodiments of the disclosure are used in a generic and descriptive sense only and not for purposes of limitation.

What is claimed is:

1. A method for providing a recommended chat room for sending a message, the method being performed by at least one processor and comprising:
identifying a user matching a name entered on a message writing screen; and
providing a recommended chat room list in which at least one chat room having the user is displayed.

2. The method of claim 1, wherein the identifying of the user comprises, based on a determination that a preset symbol is entered on the message writing screen, identifying the user matching the name that is entered consecutively to the preset symbol.

3. The method of claim 1, further comprising:
based on at least one chat room being selected from the recommended chat room list, providing a user interface (UI) for sending a message entered on the message writing screen to the selected at least one chat room.

4. The method of claim 1, wherein the providing of the recommended chat room list comprises, based on a determination that the at least one chat room having the user does not exist, displaying a new chat room creation user interface (UI) with the user in the recommended chat room list.

5. The method of claim 1, further comprising:
providing a recommended conversation history comprising conversation contents relevant to a keyword extracted from a message entered on the message writing screen among conversation contents of the at least one chat room included in the recommended chat room list.

6. The method of claim 5, wherein the providing of the recommended conversation history comprises, based on a determination that a conversation history having the user exists, displaying the recommended conversation history.

7. The method of claim 5, wherein the providing of the recommended conversation history comprises, based on a determination that a conversation history having the user does not exist, providing a recommendation function of a similar conversation history.

8. The method of claim 7, wherein the providing of the recommendation function of the similar conversation history comprises displaying the similar conversation history comprising conversation contents relevant to the keyword extracted from the message entered on the message writing screen among conversation contents of a chat room that does not include the user and comprises only a writer of the message.

9. The method of claim 5, wherein the providing of the recommended conversation history comprises:
displaying the recommended chat room list in a first area of the message writing screen, and
displaying the recommended conversation history in a second area of the message writing screen.

10. The method of claim 2, wherein the user is a first user, and wherein the method further comprises:
based on a determination that a second symbol is additionally entered on the message writing screen, identifying a second user matching a name that is entered consecutively to the additionally entered second symbol;
displaying at least one chat room having both the first user and the second user in the recommended chat room list; and
displaying conversation histories that have occurred in the at least one chat room having both the first user and the second user in a recommended conversation history.

11. The method of claim 10, wherein the displaying of the at least one chat room having both the first user and the second user in the recommended chat room list comprises, based on a determination that the at least one chat room having both the first user and the second user does not exist, displaying a new chat room creation user interface (UI) having the first user and the second user in the recommended chat room list.

12. The method of claim 10, wherein the displaying of the conversation histories that have occurred in the at least one chat room comprising both the first user and the second user in the recommended conversation history comprises providing a user interface (UI) filtering each of conversation histories of the first user and the second user displayed in the recommended conversation history.

13. The method of claim 10, wherein the displaying of the at least one chat room comprising both the first user and the second user in the recommended chat room list comprises:
displaying an individual send user interface (UI) to a one-to-one chat room having each of the first user and the second user in the recommended chat room list;
dividing a message entered on the message writing screen into a first message corresponding to the first user and a second message corresponding to the second user and, based on the individual send UI being selected, displaying the divided first message and second message; and
sending the first message to a first one-to-one chat room having the first user and sending the second message to a second one-to-one chat room having the second user.

14. The method of claim 13, further comprising:
providing a user interface (UI) for displaying a recommended conversation history corresponding to each of the first message and the second message.

15. The method of claim 10, further comprising:
displaying a chat room direct select user interface (UI) in the recommended chat room list;
based on the chat room direct select UI being selected, displaying a list of all chat room lists; and
sending the message to at least one chat room selected from the list of all chat rooms.

16. A non-transitory computer-readable recording medium storing computer program, which, when executable by at least one processor, causes the at least one processor to execute:
identify a user matching a name entered on a message writing screen; and
provide a recommended chat room list in which at least one chat room having the user is displayed.

17. A messenger client terminal comprising:
one or more processors; and
a memory configured to load a computer program executable by the one or more processors;
wherein the computer program comprises instructions for performing:
identifying a user matching a name entered on a message writing screen; and
providing a recommended chat room list in which at least one chat room having the user is displayed.

18. The messenger client terminal of claim 17, wherein the identifying of the user comprises, based on a determination that a number of users matching the entered name is plural, extracting a user relevant to a writer of the message.

19. The messenger client terminal of claim 17, wherein the computer program further comprises an instruction for providing the message writing screen based on a selection of a message writing button displayed in one area of a chat room list.

20. The messenger client terminal of claim 17, wherein the computer program further comprises an instruction for providing a recommended conversation history comprising conversation contents relevant to a keyword extracted from a message entered on the message writing screen among conversation contents of the at least one chat room included in the recommended chat room list.
